(19) United States
(12) Patent Application Publication
(10) Pub. No.: US 2017/0268964 A1
(43) Pub. Date: Sep. 21, 2017

(54) AEROSOL SAMPLING SYSTEM OPERATING AT HIGH TEMPERATURE AND PRESSURE

(71) Applicant: FNC TECHNOLOGY CO., LTD., Gyunggi-do (KR)

(72) Inventors: Byung Chul LEE, Seoul (KR); Doo Yong LEE, Gyunggi-do (KR); Chong Chan LEE, Gyunggi-do (KR); Woo Young JUNG, Gyunggi-do (KR); Hyun Chul LEE, Gyunggi-do (KR); Yong Jae SONG, Gyunggi-do (KR)

(21) Appl. No.: 15/444,616

(22) Filed: Feb. 28, 2017

(30) Foreign Application Priority Data
Feb. 29, 2016 (KR) 10-2016-0024706

(51) Int. Cl. G01N 1/22; G01F 1/684

(52) U.S. Cl. CPC G01N 1/2205; G01F 1/684; G01N 2001/2288; G01N 2001/2223

(57) ABSTRACT

The present invention relates to an aerosol sampling system operating at a high temperature and pressure, and in particular to a system which is able to sample and analyze an aerosol. The present invention aims to provide a system which is able to carry out measurements, for example, a sampling, an analysis, etc. at a high temperature and pressure, which was unavailable in the past since there is not any aerosol measuring system to sample and analyze at a high temperature and pressure.

### CROSS-REFERENCE TO RELATED PATENT APPLICATION

This application claims the benefit of Korean Patent Application No. 10-2016-0024706, filed on 29 Feb. 2017 in the Korean Intellectual Property Office. The entire disclosure of the application identified in this paragraph is incorporated herein by reference.

### FIELD

The present invention relates to an aerosol sampling system operating at a high temperature and pressure, and in particular to a system which is able to sample and analyze an aerosol. The present invention aims to provide a system which is able to carry out measurements, for example, a sampling, an analysis, etc. at a high temperature and pressure, which was unavailable in the past since there is not any aerosol measuring system to sample and analyze at a high temperature and pressure.

### BACKGROUND

Most of commercially used aerosol equipment is used under the conditions of a normal pressure/a normal temperature, a normal pressure/a high temperature, a high pressure/a room temperature, etc. There is not any commercially used aerosol equipment which can be used under a high temperature/a high pressure. For this reason, the present invention is able to provide a fundamental technology to an aerosol analysis technology which can be used under a wide environmental condition for the sake of an analysis of various aerosol including dust, pollutant and radioactive material under a high temperature/a high pressure and under various environmental conditions, for example, in the fields of a petroleum chemistry, a thermal power, a steel manufacturing, an atomic power, a vehicle, an air conditioning, and a filter, which includes a condition of a normal temperature/a normal pressure and a condition of a high temperature/a high pressure.

In this connection, the Korean patent registration number 10-0145032 describes a tool engaging and aerosol generation device, which is directed to a device for generating an aerosol under a normal temperature/a normal pressure. The technology on a system for generating/injecting, combining and sampling an aerosol of a high temperature/a high pressure.

### SUMMARY

Accordingly, it is an object of the present invention to provide an aerosol sampling system operating at a high temperature and pressure.

The aerosol measuring system should be able to adjust the flow of a sample and maintain it constantly, thus controlling the quantity of a collected aerosol. Moreover, it should be able to measure the density of particles, a size distribution and a mass concentration at various positions in such a way to use an accurate measuring equipment.

In order to measure the property of an aerosol, a device for collecting a sample is necessary. In this case, the property of the aerosol should be changed during the collection pressure. This collection procedure is called an isokinetic sampling. The aforementioned isokinetic sampling may be referred to a collection procedure under a condition where the flow direction and speed of the aerosol in a sampling probe is matched with the flow direction and speed of the aerosol in a pipe. In case of a variable speed collection, the property of an aerosol might change during the collection procedure, which may cause a wrong measurement result irrespective of the following measurement results. For this reason, the collection probe should be appropriately selected considering the flowing condition in the pipe. Furthermore, the aerosol should not be long accumulated inside the collection probe exposed to the aerosol flow before the start of the collection.

In order to sample the aerosol contained in a transfer gas under a condition of a high temperature/a high pressure containing a non-condensing type gas and a steam, a system and a device should be able to endure the condition of a high temperature/a high pressure. Moreover, it needs to confirm and collect the accuracy in the measurement in such a way to analyze uncertainty which might occur due to a difference between a sampling time and a thermal hydraulic power.

The aerosol measurement equipment, in general, uses a filter which is referred to an offline type and provides the highest accuracy when sampling the aerosol. Moreover, a variety of measurement equipment, for example, an optical particle sensor, an electrostatic low pressure impactor, etc. may be used through a sampling port so as to supplement the aforementioned matter. The offline measurement uses a membrane equipment, which is referred to a commercial available equipment, at an opening of a testing part. For this commercially available equipment, a preprocessor and a post-processor are necessary. FIG. 1 is an aerosol sampling system which is referred to an offline measuring devices and uses a membrane filter.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating a high temperature/high pressure offline aerosol measuring device according to the present invention;

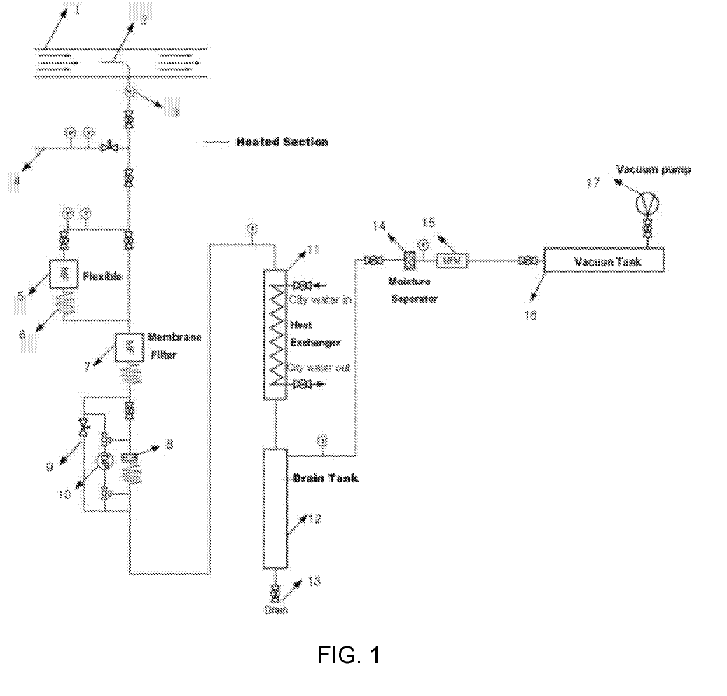

FIG. 2 is a view illustrating a filter holder which is able to endure the condition of a high temperature/a high pressure; and

FIG. 3 is a view illustrating an orifice holder and a critical orifice which are endure the condition of a high temperature/a high pressure.

### DETAILED DESCRIPTION

The present invention will be described with reference to the accompanying drawings.

In the high temperature/high pressure sampling system, a high temperature and high pressure condition must be maintained until the sampling is finished. It must be configured to lower a temperature and a pressure to a predetermined level at the time the sampling is finished, thus discharging. Moreover, the instrument and system must be configured to maintain a stable function under the condition of a high temperature/a high pressure. For this, the system is able to maintain a constant temperature from the isokinetic collection probe 2 to the rear end of the critical orifice 8 in such a way to use a heater. Any moisture is removed from the sampled collection gas as it passes through an orifice 8, a needle valve 9, a heat exchanger 11, a condensing water tank 12, and a moisture separator 14, and the pressure and the temperature thereof are lowered and are discharged to the outside of the system. Membrane filters 5 and 7 may include a holder which is specially configured to endure the condition of a high temperature/a high pressure, and a plate so as to preventing any damage to the membrane filters. The system may be configured in such a way that a filter, for example, a membrane filter, a ceramic filter, a capillary filter, etc. can be easily exchanged. Moreover, it needs to prevent a quick change in a temperature and pressure at the time of a first sampling, and a membrane filter may be additionally provided to a detour line so as to keep a balance with a transfer gas.

The transfer gas is transferred to the sampling device through the isokinetic collection probe 2, and the flow speed is maintained same at the transfer gas line 1 and the sampling line. In order to maintain the constant flow speed of the transfer gas and the sampling line, the sampling flow speed could be controlled using a vacuum pump 17 and a vacuum tank 16. The needle valve 9 and the critical orifice may be used in accordance with the used gas. If the transfer gas is a non-condensing type gas, for example, air, nitrogen, etc., the needle valve may be used to maintain the constant sampling flow speed in such a way to adjust the pressure at the rear end. If the transfer gas contains vapor, the critical orifice may be used to adjust the pressure at the rear end. The collected transfer gas may flow through a mass flow meter 3 and a thermal mass flow meter 15, thus measuring the mass flow quantity and the volume flow quantity of air, nitrogen, steam and a mixture thereof. It may be used as a means to correct any loss of the aerosol which might occur due to a flow speed difference between the transfer gas line and the sampling line.

The purge gas injector 4 is able to maintain the pressure same as or higher than the pressure of the transfer gas line in such a way to inject a small quantity of air or nitrogen gas into the inside of the sampling probe so that the aerosol cannot be long accumulated inside the collection probe exposed to the flow of the aerosol before the aerosol is collected. Moreover, in order to maintain the temperature same as the temperature of the transfer gas line, the heater is provided, thus preventing any loss of the aerosol which might occur due to a heat spreading and a condensation. Furthermore, the purge gas injector is able to perform as a dilutor so as to adjust the measuring time with respect to a high concentration aerosol which needs dilution.

Thereafter, if the collection begins, the supply of the purge gas is stopped, and it will pass through a second membrane filter 5. Since only the transfer gas from which the aerosol has been removed, is filled inside the collection pipe as it first passes through the second membrane filter just after the collection has begun, the collection can be carried out while maintaining the pressure and temperature balance between the transfer gas line and the collection line when the collection begins. So, an undesired quick collection due to the pressure difference between the transfer gas line and the collection line can be prevented, and a heat spread phenomenon wherein the aerosol is attached to the inner wall of the collection pipe due to the temperature difference can be prevented.

The sampling system which has reached the pressure/heat balance, is able to carry out the collection and measurement through the first membrane filter 7. The first and second membrane filters are connected via a flexible tube 6 and can be easily detachable.

The collection gas which has passed through the first membrane filter may have a reduced pressure after it has been passed through the critical orifice 8, and the difference pressure value can be measured using a difference pressure meter 10 installed at the front and rear ends of the critical orifice, and the flow speed of the collection gas containing the vapor can be indirectly measured. Moreover, heat can be removed by the heat exchanger 11 from a high temperature collection gas which has passed through the critical orifice or the needle valve. In case of vapor, the vapor will be condensed and collected in a drainage tank 12, and the condensed quality of the collected condensing water will be measured through the drainage valve 13. In this way, the flow quality can be accurately measured, and it may operate as a means to remove a predetermined uncertainty of the measuring device. Moreover, the pressure at the rear end can be adjusted by adjusting the valve in order for it to pass through the needle valve 9. Here, a moisture separator 14 may be provided so as to provide a good performance of the thermal mass flow meter 15, thus preventing any input of the condensed vapor.

The vacuum tank 16 and the vacuum pump 17 connected to the rear end of the membrane filter are able to adjust the flow quantity of the transfer gas which is inputted into the sampling probe.

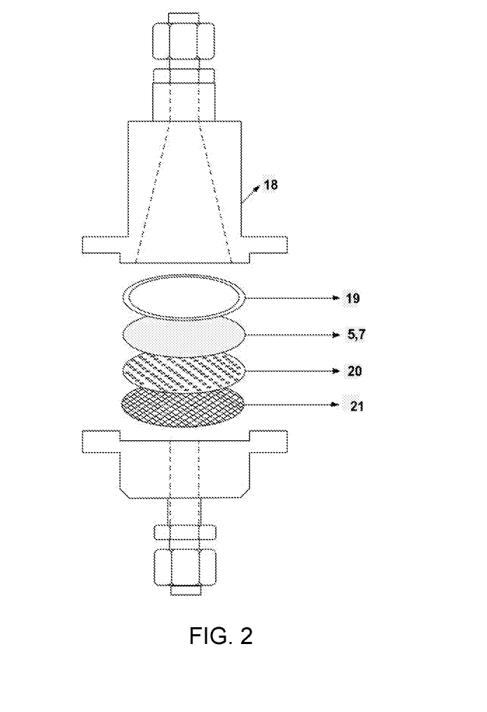

FIG. 2 is a view illustrating the filter holder 18 which is configured to endure the condition of a high temperature/a high pressure. The filter holder may be installed in a vertical direction at the sampling system, thus minimizing the loss of aerosol which has been accumulated at the membrane filter during the separation after collection. Moreover, the membrane filter can be separated and exchanged even while the system is in operation since the upper and lower parts of the filter holder are fixed using a clamp. The inside of the filter holder wherein the membrane filter is installed, may be configured in a conical shape structure which is able to form a laminar flow so as to minimize any transfer loss of the aerosol and cohesion.

In order to prevent any damage to the membrane filter under a high pressure condition, the membrane filter may be fixed on the tops of a perforated plate 20 and a mesh plate 21, thus maintaining a stabilized sampling. A Teflon ring 19 is configured to prevent any pressure loss in such a way to maintain a sealing performance under a high pressure.

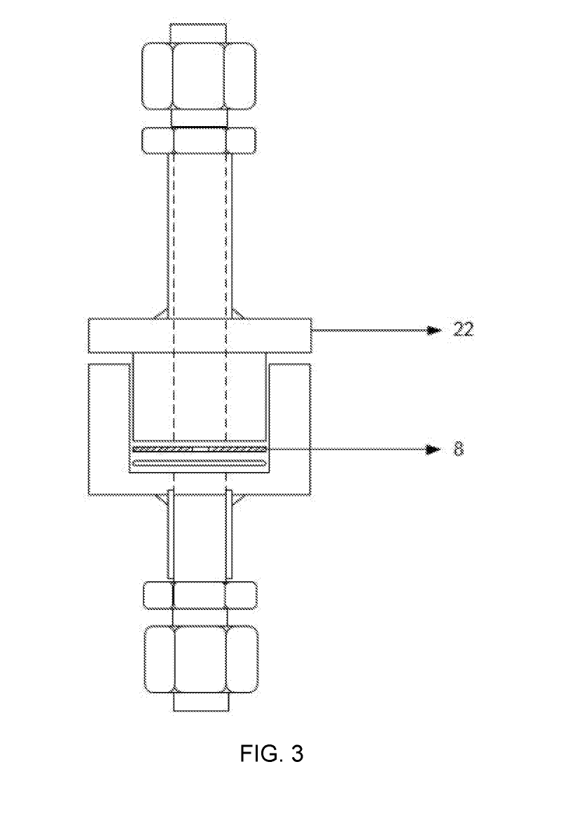

FIG. 3 is a view illustrating an orifice holder 22 and a critical orifice 8 which are configured to endure the condition of a high temperature/a high pressure. The critical office plate is fixed at the orifice holder 8. The critical office plate having a desired hole size is configured to be easily detached. So, the pressure at the rear end of the orifice can be adjusted in such a way to exchange the orifice. If the pressure difference between the front and rear ends of the orifice is over a predetermined range, the constant sampling flow speed can be maintained through the chocked flow.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### LEGEND OF REFERENCE NUMBER

1: Transfer gas line 2: Isokinetic collection probe
3 Mass flow meter 4: Purge gas injector
5: Second membrane filter 6: Flexible tube
7: First membrane filter 8: Critical orifice
9: Needle valve 10: Differential pressure gauge
11: Heat exchanger 12: Condensing tank
13: Drainage pipe 14: Moisture separator
15: Thermal mass flow meter 16: Vacuum tank
17: Vacuum pump 18: Filter holder
19: Teflon ring 20: Perforated plate
21: Mesh plate 22: Orifice holder

What is claimed is:

1. An aerosol sampling system operating a high temperature and pressure, comprising:
an isokinetic collection probe which is disposed in the same direction as a transferring direction of a transfer gas of a transfer gas line, wherein the transfer gas collected from the isokinetic collection probe is transferred to a first membrane filter, and then a collection and measurement are carried out; and
a purge gas injector which allows maintaining a pressure same as or higher than the pressure of a transfer gas line so that an aerosol is not accumulated inside a collection probe in such a way to inject a purge gas in a section defined from the isokinetic collection probe to the first membrane filter before collection begins, by which the collection can be carried out in a balanced pressure and temperature state under a high temperature/a high pressure, and the supply of the purge gas is stopped when the collection begins, and the flow thereof is detoured between the first membrane filter and the isokinetic collection probe to a second membrane filter, so the aerosol is removed by the first membrane filter, and a collection pipe is filled with only the transfer gas, whereby there is not any pressure difference and temperature difference between the transfer gas and the collection line.

2. The system of claim 1, wherein the section defined from the isokinetic collection probe and the first membrane filter is heated to have the same temperature as the transfer gas line.

3. The system of claim 2, wherein the collection gas which has passed through the first membrane filter, passes through a critical orifice, and the pressure of the collection gas is reduced, and the heat is removed from the collection gas which has passed through the critical orifice, through a heat exchanger, and the vapor is condensed and collected in a drainage tank.

4. The system of claim 3, wherein the pressure of the collection gas can be adjusted by detouring the collection gas through a needle valve before it passes through the critical orifice.

5. The system of claim 4, wherein the vapor-removed collection gas passes through a thermal mass flow meter, and a moisture separator is installed at a front end of the thermal mass flow meter.

6. The system of claim 5, wherein a vacuum tank and a vacuum pump are installed at an end of the thermal mass flow meter, thus controlling the flow quantity of the transfer which is inputted in a probe.

7. The system of claim 1, wherein in a filter holder configured to engage the membrane filter, the section defined from an opening of the filter holder to the membrane filter is formed in a conical shape structure, thus forming a laminar flow so as to minimize any transfer loss of the aerosol.

8. The system of claim 2, wherein in a filter holder configured to engage the membrane filter, the section defined from an opening of the filter holder to the membrane filter is formed in a conical shape structure, thus forming a laminar flow so as to minimize any transfer loss of the aerosol.

9. The system of claim 3, wherein in a filter holder configured to engage the membrane filter, the section defined from an opening of the filter holder to the membrane filter is formed in a conical shape structure, thus forming a laminar flow so as to minimize any transfer loss of the aerosol.

10. The system of claim 4, wherein in a filter holder configured to engage the membrane filter, the section defined from an opening of the filter holder to the membrane filter is formed in a conical shape structure, thus forming a laminar flow so as to minimize any transfer loss of the aerosol.

11. The system of claim 5, wherein in a filter holder configured to engage the membrane filter, the section defined from an opening of the filter holder to the membrane filter is formed in a conical shape structure, thus forming a laminar flow so as to minimize any transfer loss of the aerosol.

12. The system of claim 6, wherein in a filter holder configured to engage the membrane filter, the section defined from an opening of the filter holder to the membrane filter is formed in a conical shape structure, thus forming a laminar flow so as to minimize any transfer loss of the aerosol.
